(19) United States
(12) Patent Application Publication
(10) Pub. No.: US 2026/0014877 A1
(43) Pub. Date: Jan. 15, 2026

(54) VEHICLE DRIVING CONTROL APPARATUS AND METHOD

(71) Applicants: HYUNDAI MOTOR COMPANY, Seoul (KR); KIA CORPORATION, Seoul (KR)

(72) Inventors: Ha Young Woo, Gunpo-si (KR); Jin Cheol Shin, Hwaseong-si (KR); Young Joon Chang, Yongin-si (KR); Tae Woo Lee, Suwon-si (KR); Won June Nam, Ansan-si (KR); Seong Hwan Cheong, Suwon-si (KR); Seong Hun Ham, Gwangmyeong-si (KR)

(73) Assignees: HYUNDAI MOTOR COMPANY, Seoul (KR); KIA CORPORATION, Seoul (KR)

(21) Appl. No.: 18/659,453

(22) Filed: May 9, 2024

(30) Foreign Application Priority Data
Dec. 19, 2023 (KR) 10-2023-0185328

(51) Int. Cl. B60L 15/20; B60L 7/18

(52) U.S. Cl. CPC B60L 15/2063; B60L 7/18; B60L 15/2009; B60L 2240/12; B60L 2240/423; B60L 2240/486; B60L 2250/16; B60L 2260/167; B60L 2260/24; B60L 2260/26

(57) ABSTRACT

A vehicle driving control apparatus and method are capable of eliminating problems in conventional stop control provided in an electric vehicle. The vehicle driving control apparatus includes a manipulation device, an input device, a driving information detector, and a controller connected thereto. The controller determines whether the vehicle speed detected by the vehicle speed detector is not higher than a predetermined reference speed for creep initiation, when the on state of the one-pedal mode is selected through the manipulation device and creep allowance in parking is set through the input device. The controller controls a motor configured to drive the vehicle such that the motor generates a creep torque in the on state of the one-pedal mode, in response to determining that the vehicle speed is not higher than the predetermined reference speed for creep initiation.

### CROSS-REFERENCE TO RELATED APPLICATION

This application claims, under 35 U.S.C. § 119(a), the benefit of and priority to Korean Patent Application No. 10-2023-0185328, filed on Dec. 19, 2023, the entire contents of which are incorporated herein by reference.

### TECHNICAL FIELD

The present disclosure relates to a vehicle driving control apparatus and method.

### BACKGROUND

In accordance with an increased tendency of consumers toward driving convenience as an important factor taken into consideration when purchasing a vehicle, requirement of new pedal systems is increasing. As an example of such a pedal system, one-pedal driving technology is known.

One-pedal driving is a system capable of allowing a driver to not only accelerate/decelerate a vehicle, but also to bring the vehicle to a stop using only an accelerator pedal without pressing a brake pedal, through utilization of regenerative braking by a motor. In a one-pedal mode, the driver can stop the vehicle by only taking the driver's foot off the accelerator pedal.

Such one-pedal driving technology utilizes regenerative braking by a motor for vehicle deceleration or stop. The one-pedal driving technology may thus be used in a hybrid vehicle or in an electric vehicle that is driven by a motor.

Some electric vehicle manufacturers offer one-pedal driving as a basic option in a vehicle. Otherwise, in the case of a vehicle in which a plurality of regenerative braking levels is set, the vehicle is set such that a one-pedal mode (for example, an i-pedal mode) is performed when the driver selects a maximum level of regenerative braking strength through a manipulation device such as a paddle shifter or the like.

In an electric vehicle, stop control for decelerating the vehicle to a stop state in a one-pedal mode may be provided. In conventional stop control, however, there is a problem in that the driver cannot select a degree of deceleration applied to the vehicle by the motor in order to stop the vehicle.

In addition, there is a problem in that, since a degree of deceleration is excessive when a mode for stop control is activated, motion sickness of a passenger may occur. Furthermore, there is a problem in that, when a gear stage is shifted from a D-stage to an R-stage for parking, stop control is automatically released. As a result, there is no consistency in driving as far as the driver is concerned.

In the related art, it is impossible to perform stop control at a regenerative strength and level desired by the driver. Stop control is provided only at a maximum regenerative strength and level. Accordingly, continuous adjustment of an accelerator pedal input amount is required. This causes an increase in driver fatigue. A great acceleration variation generated in tip-out is a main cause of motion sickness of a passenger.

In addition, in the related art, user convenience is not taken into consideration when a stop control mode is selected. Furthermore, there is inconvenience in that, since stop control is automatically released upon gear shift to an R-stage, a one-pedal mode (for example, an i-pedal mode) should be again switched on through manual paddle manipulation after return of the gear stage to a D-stage. In the case of a vehicle in which stop control is always provided even when the gear stage is shifted to the R-stage, creeping is impossible. In this case, accordingly, parking may be inconvenient for the driver.

Furthermore, in the related art, unnecessary use of a motor torque during stop control may degrade fuel economy. Output lowering may occur due to excessive heat of a motor. Devices of a cooling system such as an electric water pump (EWP), a radiator fan, etc. should be frequently operated in order to prevent output lowering. As a result, there may be a noise problem.

### SUMMARY

The present disclosure has been made in an effort to solve the above-described problems associated with the prior art. Objects of the present disclosure is to provide a vehicle driving control apparatus and method capable of eliminating various problems involved in conventional stop control.

Objects of the present disclosure are not limited to the above-described objects. Other objects of the present disclosure not mentioned herein may be more clearly understood by those having ordinary skill in the art from the following detailed description. Objects of the present disclosure may be accomplished by means defined in the appended claims and combinations thereof.

In one aspect, a driving control apparatus of a vehicle is provided. The driving control apparatus includes a manipulation device configured to allow selection of on/off states of a one-pedal mode. The driving control apparatus also includes an input device configured to allow setting of creep allowance in parking or creep prohibition in parking. The driving control apparatus additionally includes a vehicle speed detector configured to detect a vehicle speed. The driving control apparatus further includes a controller connected to the manipulation device, the input device, and a driving information detector. The controller is configured to determine whether the vehicle speed detected by the vehicle speed detector is not higher than a predetermined reference speed for creep initiation, when i) the on state of the one-pedal mode is selected through the manipulation device and ii) creep allowance in parking is set through the input device. The controller is also configured to control a motor configured to drive the vehicle such that the motor generates a creep torque in the on state of the one-pedal mode, upon determining that the vehicle speed is not higher than the predetermined reference speed for creep initiation.

In an embodiment, the controller may be further configured to control operation of a display device to display a user setting menu for enabling a driver to select one of creep allowance in parking and creep prohibition in parking. The controller may be configured to receive setting information as to creep allowance in parking or creep prohibition in parking selected by the driver, through the input device.

In an embodiment, the controller may be further configured to determine whether a previous gear stage is an R-stage and whether a current stage is a D stage, when i) the on state of the one-pedal mode is selected and ii) creep allowance in parking is set. The controller may also be configured to determine whether the vehicle speed is not higher than the predetermined reference speed for creep initiation, in response to determining that i) the previous gear stage is the R-stage and ii) the current stage is the D stage.

In an embodiment, the controller may be further configured to perform a control operation for the one-pedal mode when the vehicle is accelerated in the on state of the one-pedal mode such that the vehicle speed is not lower than a predetermined critical speed for acceleration determination, after controlling the motor to generate the creep torque.

In an embodiment, a plurality of regenerative braking levels may be set in the controller. The controller may be configured to control the motor by a coasting torque corresponding to a regenerative braking level currently selected from among the plurality of regenerative braking levels during execution of a control operation for the one-pedal mode, thereby decelerating the vehicle.

In an embodiment, a plurality of regenerative braking levels respectively corresponding to different coasting torques according to a vehicle speed and selectable by a driver may be set in the controller. The controller may be configured to determine a coasting torque corresponding to a real-time vehicle speed according to the regenerative braking level selected by the driver and may control the motor by the determined coasting torque during execution of the control operation for the one-pedal mode, thereby decelerating the vehicle.

In an embodiment, a plurality of regenerative braking levels may be set in the controller. the controller may be configured to control the motor by a coasting torque corresponding to a regenerative braking level currently selected from among the plurality of regenerative braking levels during execution of the control operation for the one-pedal mode. The controller may also be configured to linearly vary a costing torque according to each of the regenerative braking levels from a predetermined coasting-variable reference speed to a predetermined stop control entrance speed in a coasting torque convergence range as a vehicle speed range i) not higher than the predetermined coasting-variable reference speed and ii) not lower than the predetermined stop control entrance speed.

In an embodiment, coasting torques of the plurality of regenerative braking levels may be set, in the controller, to be converged to a same torque value at the predetermined stop control entrance speed. The coasting torques of the plurality of regenerative braking levels may be set, in the controller, to have the same value in a stop control range from the predetermined stop control entrance speed to 0 km/h. The costing torques set to have the same value in the stop control range may be linearly reduced in accordance with a reduction in vehicle speed.

In an embodiment, a plurality of regenerative braking levels may be set in the controller. The controller may be configured to control the motor by a coasting torque corresponding to a regenerative braking level currently selected from among the plurality of regenerative braking levels, in response to determining that i) the one-pedal mode is in the one state and ii) creep prohibition in parking is set.

In an embodiment, the controller may be further configured to, in response to determining that the vehicle speed becomes lower than the predetermined stop control entrance speed in an accelerator pedal off state during control of the motor by the coasting torque, control operation of a brake device to apply braking force until the vehicle stops.

In an embodiment, the controller may be further configured to, in response to determining that the vehicle speed becomes lower than the predetermined stop control entrance speed, control operation of the brake device to apply a braking force when the vehicle speed subsequently becomes lower than a predetermined reference speed for braking application.

In an embodiment, the controller may be further configured to control operation of the brake device to increase the braking force, upon determining that stop of the vehicle has been completed by the braking force of the brake device, and the controller may perform motor torque removal to control the motor such that a motor torque of the motor becomes zero, after the braking force increases.

In an embodiment, the controller may be further configured to store a motor torque maintained just before execution of the motor torque removal. The controller may also be configured to release operation of the brake device when an accelerator pedal input by a driver is subsequently generated, and concurrently control operation of the motor to generate the stored motor torque.

In an embodiment, a plurality of regenerative braking levels respectively corresponding to different coasting torques according to a vehicle speed and selectable by a driver may be set in the controller. The controller may be configured to control the motor by a coasting torque corresponding to a real-time vehicle speed according to the regenerative braking level selected by the driver, in response to determining that i) the one-pedal mode is in the one state and ii) creep prohibition in parking is set.

In another aspect, a driving control method of a vehicle is provided. The driving control method includes determining, by a controller, on/off states of a one-pedal mode and information as to setting of creep allowance in parking/creep prohibition in parking. The driving control method also includes determining, by the controller, whether or not a vehicle speed is not higher than a predetermined reference speed for creep initiation, in response to determining that i) the one-pedal mode is in the on state and ii) creep allowance in parking is set. The driving control method additionally includes controlling, by the controller, a motor configured to drive the vehicle such that the motor generates a creep torque in the on state of the one-pedal mode, when the vehicle speed is not higher than the predetermined reference speed for creep initiation.

In an embodiment, the driving control method may further include determining, by the controller, whether a previous gear stage is an R-stage and whether a current stage is a D stage, in response to determining that i) the one-pedal mode is in the on state and ii) creep allowance in parking is set, before determining whether or not the vehicle speed is not higher than the predetermined reference speed for creep initiation. Determining whether or not the vehicle speed is not higher than the predetermined reference speed for creep initiation may be performed in response to determining that the previous gear stage is the R-stage, and the current stage is the D stage.

In an embodiment, the driving control method may further include performing, by the controller, a control operation for the one-pedal mode when the vehicle is accelerated in the on state of the one-pedal mode such that the vehicle speed is not lower than a predetermined critical speed for acceleration determination, after controlling the motor to generate the creep torque.

In an embodiment, the driving control method may further include controlling, by the controller, the motor by a coasting torque corresponding to a regenerative braking level currently selected from among a plurality of regenerative braking levels during execution of a control operation for the one-pedal mode, thereby decelerating the vehicle.

In an embodiment, a plurality of regenerative braking levels may be set in the controller. The driving control method may include controlling, by the controller, the motor by a coasting torque corresponding to a regenerative braking level currently selected from among the plurality of regenerative braking levels during execution of a control operation for the one-pedal mode. The driving control method may include linearly varying, by the controller, a costing torque according to each of the regenerative braking levels from a predetermined coasting-variable reference speed to a predetermined stop control entrance speed in a coasting torque convergence range as a vehicle speed range i) not higher than the predetermined coasting-variable reference speed and ii) not lower than the predetermined stop control entrance speed.

In an embodiment, coasting torques of the plurality of regenerative braking levels may be set, in the controller, to be converged to a same torque value at the predetermined stop control entrance speed. The coasting torques of the plurality of regenerative braking levels may be set, in the controller, to have a same value in a stop control range from the predetermined stop control entrance speed to 0 km/h. The costing torques set to have the same value in the stop control range may be linearly reduced in accordance with a reduction in vehicle speed.

In an embodiment, the driving control method may further include controlling, by the controller, the motor using a coasting torque corresponding to a regenerative braking level currently selected from among a plurality of regenerative braking levels, under a condition that the plurality of regenerative braking levels is set in the controller, upon determining that the one-pedal mode is in the one state, and creep prohibition in parking is set.

In an embodiment, the driving control method may further include determining, by the controller, whether the vehicle speed becomes lower than a predetermined stop control entrance speed in an accelerator pedal off state during control of the motor by the coasting torque. The driving control method may additionally include controlling, by the controller, operation of a brake device to apply braking force until the vehicle stops, upon determining that the vehicle speed becomes lower than the predetermined stop control entrance speed.

In an embodiment, the driving control method may further include, in response to determining that the vehicle speed becomes lower than the predetermined stop control entrance speed, controlling, by the controller, operation of the brake device to apply a braking force when the vehicle speed becomes lower than a predetermined reference speed for braking application.

In an embodiment, the driving control method may further include controlling, by the controller, operation of the brake device to increase the braking force, in response to determining that stop of the vehicle has been completed by the braking force of the brake device. The driving control method may additionally include performing, by the controller, motor torque removal to control the motor such that a motor torque of the motor becomes zero, after the braking force increases.

In an embodiment, the driving control method may further include storing, by the controller, a motor torque maintained just before execution of the motor torque removal. The driving control method may also include releasing, by the controller, operation of the brake device when an accelerator pedal input by a driver is subsequently generated, and concurrently controlling, by the controller, operation of the motor to generate the stored motor torque.

Other aspects and embodiments of the present disclosure are described below.

The above and other features of the present disclosure are described below.

In the vehicle driving control apparatus and method according to embodiments of the present disclosure, stop control at all regenerative braking levels may be provided. Accordingly, stop control may be performed even at a low regenerative braking level.

According to embodiments of the present disclosure, since a linear coasting torque is set to enable the vehicle to be completely stopped after being gradually decelerated in a range lower than the coasting-variable reference speed, it is unnecessary for the driver to repeatedly manipulate the accelerator pedal due to excessive deceleration. A deceleration variation upon tip-out for coasting in the one-pedal mode is also not excessive. As a result, motion sickness of a passenger does not occur.

In addition, according to embodiments of the present disclosure, the driver may select creep allowance or creep prohibition through a user setting menu. When the driver selects “creep allowance in parking”, the one-pedal mode is temporarily deactivated under the condition that the gear stage is shifted to the R-stage during parking. Accordingly, creeping may be performed.

In addition, when an acceleration intention of the driver is identified under the condition that the gear stage is subsequently returned to the D-stage, the one-pedal mode may be activated. Accordingly, an effort of the driver to again switch on the one-pedal mode through manual manipulation, as in conventional cases, may be unnecessary.

On the other hand, when the driver wants stop control even in the R-stage, the driver is allowed to select “creep prohibition in parking”. In this case, it may be possible for the driver to experience consistent stop control in both the D-stage and the R-stage.

In addition, according to embodiments of the present disclosure, unnecessary motor torque after completion of vehicle stop determination may be removed. Accordingly, fuel economy in the one-pedal mode may be enhanced, and over-heating of a power electric (PE) system including a motor may be prevented.

Furthermore, according to embodiments of the present disclosure, when stop control is released, a motor torque is rapidly applied in order to prevent occurrence of a vehicle slipping phenomenon. Accordingly, an enhancement in drivability may also be achieved.

### BRIEF DESCRIPTION OF THE DRAWINGS

The above and other features of the present disclosure are described in detail below with reference to certain embodiments thereof illustrated in the accompanying drawings, which are given hereinbelow by way of illustration only, and thus are not limitative of the present disclosure, and in which:

FIG. 1 is a block diagram illustrating a configuration of a control apparatus for performing stop control, according to an embodiment of the present disclosure;

FIG. 2 is a view illustrating a display screen of an output device configured to set whether creep is allowable in parking, according to an embodiment of the present disclosure;

FIG. 3 is a view illustrating an example in which a one-pedal mode on or off state is displayed on a cluster, according to an embodiment of the present disclosure;

FIG. 4 is a view illustrating an example in which a deactivation state of a one-pedal function is displayed on a cluster, according to an embodiment of the present disclosure;

FIG. 5 is a view illustrating a coasting torque setting example according to the related art;

FIGS. 6 and 7 are views illustrating examples of coasting torque setting, according to an embodiment of the present disclosure;

FIG. 8 is a view illustrating a state in which stop control is performed, according to an embodiment of the present disclosure;

FIG. 9 is a flowchart illustrating procedures for one-pedal mode on/off determination and stop control entrance determination according to the related art;

FIG. 10 is a flowchart of a method for determining stop control, creeping, and coasting, according to an embodiment of the present disclosure;

FIG. 11 is a flowchart illustrating a stop control procedure according to the related art; and

FIG. 12 is a flowchart of a method for stop control, according to an embodiment of the present disclosure.

It should be understood that the appended drawings are not necessarily drawn to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment.

In the figures, identical reference numbers refer to the same or equivalent parts of the present disclosure throughout the several figures of the drawings.

### DETAILED DESCRIPTION

In the following description, specific structural or functional descriptions are illustrative to merely describe the embodiments of the present disclosure. Embodiments of the present disclosure can be implemented in various forms. In addition, the present disclosure should not be interpreted as being limited to the embodiments described in the present specification. It should be understood that the present disclosure includes all changes, equivalents, or substitutions within the spirit and scope of the present disclosure.

It should be understood that, although terms such as “first”, “second”, etc. may be used herein to describe various elements, these elements are not to be limited by these terms. These terms are only used to distinguish one element from another element. For instance, a “first” element could be termed a “second” element without departing from the scope of the present disclosure. Similarly, the “second” element could also be termed a “first” element.

In the case where an element is “connected” or “linked” to another element, it should be understood that the element may be directly connected or linked to the other element, or another element may be present therebetween. On the contrary, in the case where an element is “directly connected” or “directly linked” to another element, it should be understood that no other element is present therebetween. Other expressions describing a relationship between constituent elements, such as “between ^{˜}” and “immediately between ^{˜}”, or “adjacent to ^{˜}” and “directly adjacent to ^{˜}”, and the like, should be construed in a similar manner.

Throughout the specification, the same reference numerals refer to the same elements. It is noted that terms used herein are merely used to describe a specific embodiment, not to limit the present disclosure. Unless clearly used otherwise, singular expressions include a plural meaning. In this application, terms such as “comprises”, “comprising”, “includes”, “including”, and the like are intended to express the existence of the mentioned constituent element, step, operation, and/or device, and do not exclude the existence or addition of another constituent element, step, operation, and/or device. The same is intended for words such as “have” and “include” and variations.

When a component, device, element, or the like of the present disclosure is described as having a purpose or performing an operation, function, or the like, the component, device, or element should be considered herein as being “configured to” meet that purpose or perform that operation or function.

The term “unit”, “module”, “controller”, or the like, used in the present disclosure signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

According to embodiments of the present disclosure, a vehicle driving control apparatus and method are provided and are capable of eliminating various problems involved in stop control in existing electric vehicles.

Embodiments of the present disclosure provide the following functions.

According to embodiments, stop control at all regenerative braking levels is provided irrespective of a regenerative strength and level in an electric vehicle. Further, according to embodiments, a function for preventing occurrence of motion sickness is provided in a procedure in which the vehicle is decelerated to a predetermined speed for entrance to stop control.

To this end, according to embodiments, coasting torques in a stop control range are set to be equally reduced (to be reduced with reference to absolute values thereof) irrespective of a regenerative braking level (regenerative strength).

In addition, according to embodiments, a coasting torque is linearly converged in a procedure in which the vehicle is decelerated to a stop control range. The linearly-converged coasting torque may reduce abrupt deceleration caused by tip-out, and may prevent occurrence of motion sickness of a passenger.

According to embodiment, a function is provided for enabling selective generation of a creep torque.

To this end, according to embodiments, the vehicle is allowed to generate a creep torque by a motor in parking when the driver desires and selects generation of the creep torque. In more detail, generation of a creep torque is switched on/off through checking of “creep allowance in parking”, “creep prohibition in parking”, etc. In order to generate a creep torque only in parking, a one-pedal (for example, i-pedal) function is temporarily deactivated when a gear stage is shifted to an R-stage, thereby allowing creeping.

Even when the gear stage is subsequently returned to a D-stage, a current state of the vehicle is recognized as a parking state until the vehicle is accelerated. Accordingly, no stop control is performed and convenience of parking is provided. When an acceleration intention of the driver is identified as the vehicle is accelerated to the predetermined vehicle speed or more by the driver, the one-pedal function is again activated and. Accordingly, a state capable of providing stop control is obtained.

According to embodiments, fuel economy and drivability associated with stop control are enhanced.

To this end, according to embodiments, a stop state of the vehicle is maintained by a hydraulic brake after completion of vehicle stop by the one-pedal (i-pedal). In this case, an unnecessary motor torque is not generated. Accordingly, an effect of enhancing fuel economy may be obtained.

In addition, when a value maintained just before removal of the motor torque is stored, and stop control is subsequently released in accordance with application of an accelerator pedal input, the motor torque is rapidly returned to the stored value. Accordingly, it may be possible to minimize vehicle impact generation, vehicle shaking, and noise generation in tip-in.

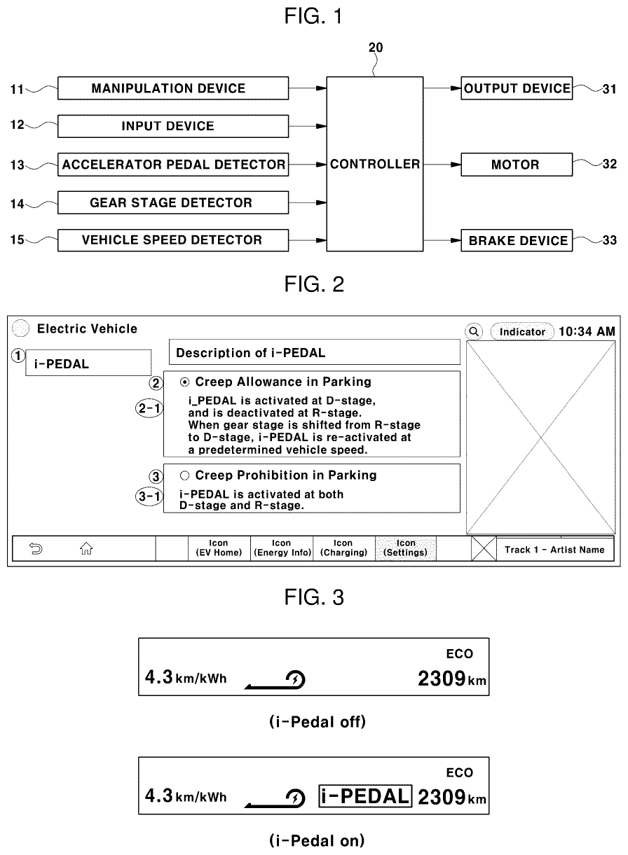

FIG. 1 is a block diagram illustrating a configuration of a control apparatus for performing stop control, according to an embodiment of the present disclosure. As shown in FIG. 1, the control apparatus for performing a stop control procedure may include a manipulation device 11, an input device 12, a driving information detector, a controller 20, an output device 31, a motor 32, and a brake device 33.

The control apparatus according to embodiments of the present disclosure may be configured such that a one-pedal mode is switched on/off when the driver manipulates the manipulation device 11 provided at a vehicle driver seat. To this end, the manipulation device 11 may be electrically connected to the controller 20. Accordingly, when the driver manipulates the manipulation device 11, an electrical signal according to a manipulated state of the manipulation device 11 may be input to the controller 20.

In the control apparatus according to embodiments of the present disclosure, the manipulation device 11 may be provided to be manipulated for selection of a regenerative braking level by the driver. The manipulation device 11 may be a paddle shifter, such as a paddle attached to a steering wheel of the vehicle. In a concrete example, the one-pedal mode may be configured to be switched on/off when a left paddle is maintained in a hold state.

In addition, the control apparatus according to embodiments of the present disclosure may be configured such that the driver manipulates the paddle to select a regenerative braking level desired by the driver. For example, a plurality of regenerative braking levels, such as regenerative braking levels D0, D1, D2, and D3, may be set in the controller 20, and the driver may select one of the plurality of regenerative braking levels by manipulating the paddle. In this case, the plurality of regenerative braking levels are set by dividing a regenerative strength into several levels in order to enable the driver to select one thereof.

When manipulation of the one-pedal function is provided in a toggle manner, the controller 20 may be set to switch on the one-pedal mode in a hold state of the left paddle under the condition that a previous state is an off state. Further, the controller 20 may be set to switch off the one-pedal mode in the hold state of the left paddle under the condition that the previous state is an on state.

In the following description, switching-on and switching-off of the one-pedal mode are distinguished from activation and deactivation of the one-pedal function performed in accordance with setting performed by the driver through the input device 12. Switching-on/off of the one-pedal function performed through manipulation of the manipulation device 11 such as the paddle or the like installed at the steering wheel by the driver is defined as switching-on/off of the one-pedal mode.

The input device 12 may be a separate manipulation device provided to enable the driver to select one of “creep allowance in parking” and “creep prohibition in parking”, as described in more detail below. The input device 12 may be a touchscreen input device configured to be integrated with a display device of the vehicle.

According to embodiments of the present disclosure, when the driver selects “creep allowance in parking”, the one-pedal function is deactivated in a parking mode even in an on state of the one-pedal mode. Accordingly, generation of a creep torque and creeping in the vehicle are allowed. On the other hand, when the driver selects “creep prohibition in parking”, the vehicle is always controlled to be stopped through stop control without generation of a creep torque in the on state of the one-pedal mode.

The driving information detector is configured to detect vehicle driving information representing a vehicle driving state. The driving information detector may include an accelerator pedal detector 13 configured to detect an accelerator pedal input value (APS value, %). The driving information detector may also include a gear stage detector 14 configured to detect a gear stage state such as input and change of a gear stage or the like. The driving information detector may additionally include a vehicle speed detector 15 configured to detect a vehicle speed.

The accelerator pedal detector 13 may be a known accelerator pedal position sensor (APS) configured to output an electrical signal according to an accelerator pedal input of the driver and a manipulation state of the accelerator pedal. The controller 20 may obtain the accelerator pedal input value of the driver and accelerator pedal on/off information from the electrical signal output from the accelerator pedal detector 13.

The gear stage detector 14 may be configured to output a signal representing a gear stage state selected by the driver. The controller 20 may obtain gear stage information representing a real-time gear stage state such as a forward driving stage, (e.g., a D-stage), a reverse driving stage (e.g., R-stage), etc. from the signal output from the gear stage detector 14.

The vehicle speed detector 15 may be a general sensor configured to detect a vehicle speed, and may include a wheel speed sensor. Obtaining vehicle speed information from a signal from the wheel speed sensor is a well-known technology in the present technical field. Accordingly, no detailed description thereof is provided herein.

The controller 20 is used to obtain necessary information from signals input from the manipulation device 11 and the input device 12 and signals input from individual detection elements of the driving information detector, including the accelerator pedal detector 13, the gear stage detector 14, and the vehicle speed detector 15. The controller 20 may use the obtained information for execution of stop control.

In addition, the controller 20 may be configured to determine a driver required torque based on real-time vehicle driving information obtained through the driving information detector in the vehicle and to generate and output a motor torque command for satisfying the determined driver required torque. Furthermore, the controller 20 may be configured to control operation of the motor 32, configured to drive the vehicle, in accordance with the motor torque command. The controller 20 may also be configured to control operation of the brake device 33.

Although the single controller 20 is shown in FIG. 1 as a control subject, this is illustrative, and the present disclosure is not limited thereto. The stop control procedure according to embodiments of the present disclosure may also be performed by a plurality of controllers in place of a single controller.

When a plurality of controllers is used, the control procedure according to embodiments of the present disclosure may be performed through cooperative control of an upper-level controller and a lower-level controller. For example, the control procedure according to embodiments of the present disclosure may be performed through cooperative control of a vehicle control unit (VCU), which is an upper-level controller, and a motor control unit (MCU), a brake control unit (BCU), etc., which are lower-level controllers.

The controller 20 of FIG. 1 may collectively refer to both an integrated signal controller and a plurality of controllers configured to execute the control procedure according to embodiments of the present disclosure, or may represent only an upper-level controller configured to execute cooperative control with a lower-level controller, for stop control according to embodiments of the present disclosure.

In the following description, the controller 20 of FIG. 1 is described as executing the entirety of the control procedure according to embodiments of the present disclosure. In this case, the controller 20 collectively refers to a single controller or a plurality of controllers configured to execute the control procedure according to embodiments of the present disclosure.

The output device 31 may include a display device configured to display information such as a user setting menu, etc. in order to enable the driver to select one of “creep allowance in parking” and “creep prohibition in parking”. The display device may include a display separate from a cluster. The separate display may be a display device of a vehicle audio, video, navigation and telematics (AVNT) system.

The motor 32 is a motor configured to drive the vehicle. The brake device 33 may be a frictional braking device. For example, the brake device 33 may be a general hydraulic braking device (a hydraulic brake) configured to control frictional braking force applied to a vehicle wheel in accordance with control of a hydraulic braking amount.

FIG. 2 is a view illustrating a user setting screen provided through the display device of the output device 31, for example, a display device of an AVNT system, in order to enable the driver to select a control mode in a one-pedal on state in accordance with a parking tendency of the driver, according to an embodiment. FIG. 2 illustrates a screen for setting whether creep is allowable in parking, according to an embodiment.

According to embodiments of the present disclosure, the driver may select one of “creep allowance in parking” and “creep prohibition in parking”. When “creep allowance in parking” is selected, the one-pedal function is deactivated in parking even in an on state of the one-pedal mode. Accordingly, generation of a creep torque is possible. On the other hand, when “creep prohibition in parking” is selected, generation of a creep torque is not allowed in parking, and deactivation of the one-pedal function is prevented. Accordingly, parking control is normally performed.

For reference, in FIG. 2, “i-PEDAL” means the one-pedal function. In the following description, “i-pedal” has the same meaning as one-pedal. In addition, an activation state of the i-PEDAL means a state in which normal stop control may be performed in an on state of the one-pedal function under the condition that generation of a creep torque is prevented.

When “creep allowance in parking” is marked and checked, the controller 20 is set to temporarily release (deactivate) the one-pedal function, i.e., an i-pedal function, upon gear shift to the R-stage and to maintain the released state of the one-pedal function even immediately after return of the gear stage to the D-stage.

The released state is a state in which a creep torque is generated even when the driver takes his or her foot off the accelerator pedal in parking. This state is defined as an i-pedal (one-pedal) deactivation state. The i-pedal deactivation state is a state in which the i-pedal function and stop control are temporarily released upon gear shift to the R-stage.

In addition, when the vehicle is accelerated to a critical speed for acceleration determination set in the i-pedal deactivation state or more, under the condition that “creep allowance in parking” is marked and checked, the controller 20 determines that parking has been completed. Accordingly, is set to activate stop control by the i-pedal function.

On the other hand, when “creep prohibition in parking” is marked and checked, the controller 20 is set to always activate the i-pedal function during driving. Accordingly, the controller 20 is set to always perform and provide stop control irrespective of the D-stage or the R-stage.

When the i-pedal function is activated, the vehicle speed is gradually decelerated in a coasting state. When the vehicle speed becomes lower than a predetermined stop control entrance speed (e.g., 3 km/h), the controller 20 starts and performs stop control (switching-on of stop control), and then maintains a stop control state until stop control release by the accelerator pedal occurs.

FIG. 3 is a view showing an example in which a one-pedal mode on or off state is displayed on a cluster which is another display device, according to an embodiment of the present disclosure. In the one-pedal mode off (i-pedal off) state, “i-PEDAL” is not displayed. However, in a one-pedal mode on (i-pedal on) state, “i-PEDAL” is displayed on a cluster (e.g., the output device 31), thereby informing the driver of the one-pedal mode on state. The one-pedal mode on state of FIG. 3 is an activation state of the one-pedal function.

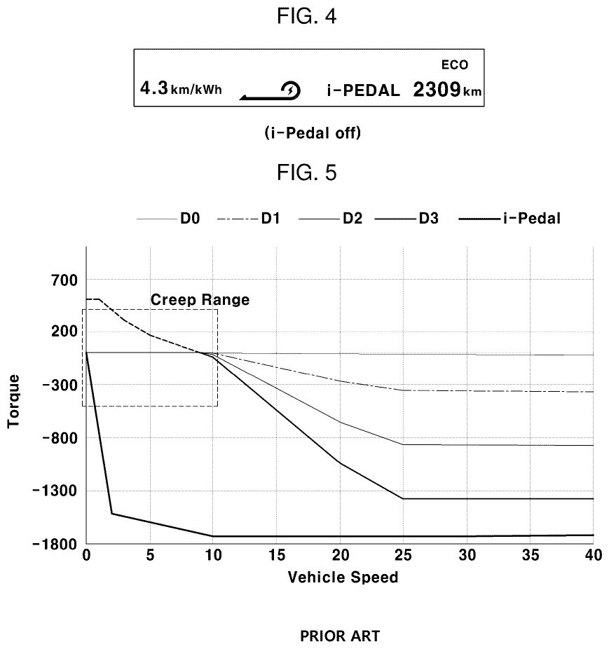

FIG. 4 is a view showing an example in which a deactivation state of the one-pedal function is displayed on a cluster, according to an embodiment of the present disclosure. FIG. 4 illustrates a state in which a rectangular box is omitted from an “i-PEDAL” symbol in FIG. 3, in order to distinguish a deactivation state of the one-pedal function from the state of FIG. 3. In another example, in the deactivation state, the color of characters in the “i-PEDAL” symbol may be changed into a color different from that of the activation state of FIG. 3 (for example, gray).

When the driver selects “creep allowance in parking” even though the one-pedal mode is in an on state, the deactivation state shown in FIG. 4 is displayed and maintained after gear shift to the R-stage and until acceleration intention is identified after return of the gear stage to the D-stage.

Hereinafter, a comparison of a mapping state of a coasting torque and a creep torque with respect to a vehicle speed according to embodiments of the present disclosure with that of a conventional case is provided.

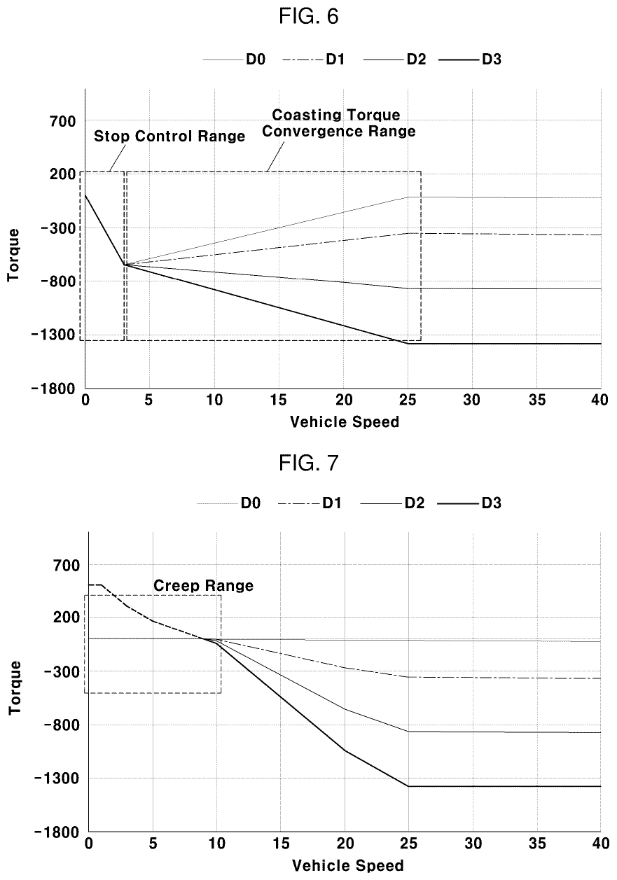

FIG. 5 is a view illustrating a coasting torque setting example according to the related art. FIGS. 6 and 7 are views illustrating setting data obtained through mapping of a coasting torque and a creep torque with respect to vehicle speed according to embodiments of the present disclosure.

FIG. 6 illustrates a coasting torque according to a vehicle speed in one-pedal on and activation states, according to an embodiment. FIG. 7 illustrates a coasting torque according to a vehicle speed in a one-pedal off or deactivation state, according to an embodiment.

The illustrated setting data may be used in determining a coasting torque value and a creep torque value according to a vehicle speed in the controller 20. The illustrated data is in the form of a map defining correlations between vehicle speed and coasting torque and among vehicle speed, coasting torque, and creep torque.

As shown in FIG. 5, in the related art, a plurality of regenerative braking levels distinguished from one another in accordance with different regenerative strengths thereof is set, and a one-pedal (i-pedal) level is provided as a level having a maximum regenerative strength (a max. level).

Referring to the example of FIG. 5, it can be seen that a coasting torque is set as a torque in a negative (−) direction with respect to a vehicle speed, i.e., a torque having a negative value. A level D0, at which no regenerative braking is performed, and three regenerative braking levels D1, D2, and D3, which are distinguished from one another in accordance with different regenerative strengths thereof, respectively, are provided. A higher absolute value of coasting torque with reference to the same vehicle speed is set at the level D2 than at the level D1, and is set at the level D3 than at the level D2.

In addition, at the levels D0-D3, a coasting torque converges to 0 at a vehicle speed set to be 10 km/h or less. A creep torque is generated and provided at a speed lower than the set vehicle speed. On the other hand, at the one-pedal (i-pedal) level, the vehicle is controlled to be stopped only by a coasting torque without generation of a creep torque.

On the other hand, according to embodiments of the present disclosure, first setting data used in one-pedal mode on and activation states and second setting data used in a one-pedal mode off or deactivation state are separately set and provided at the controller 20.

In accordance with the first setting data, vehicle speed is gradually reduced at each regenerative braking level in a “coasting torque convergence range”, which is a vehicle speed range not higher than a predetermined coasting-variable reference speed (for example, 25 km/h) but not lower than a predetermined stop control entrance speed (for example, 3 km/h). Accordingly, a coasting torque is set to be linearly varied.

In association with coasting torques in a range from the coasting-variable reference speed to the stop control entrance speed (for example, 3 km/h), levels of coasting torques and variation gradients of coasting torques at different regenerative braking levels D0-D3 are set to have different values, respectively, in order to distinguish regenerative strengths from one another stepwise.

In addition, in accordance with the first setting data used the one-pedal mode one and activation states, a coasting torque is set to have a negative (−) value linearly reduced until the vehicle speed reaches the stop control entrance speed, even at the level D0, which is a regenerative braking level having a lowest regenerative strength.

The “coasting torque convergence range” in FIG. 6 is a range in which a coasting torque is linearly varied until the vehicle speed is reduced from the coasting-variable reference speed to the stop control entrance speed. In the coasting torque convergence range, coasting torques of all levels are linearly varied. Accordingly, the coasting torques of all levels are converged to a predetermined torque value when the vehicle speed reaches the stop control entrance speed.

According to embodiments of the present disclosure, a part of the plurality of regenerative braking levels, for example, D0 and D1, may be set such that an absolute value of coasting torque increases gradually in the coasting torque convergence range. Further, the remaining part of the plurality of regenerative braking levels, for example, D2 and D3, may be set such that an absolute value of coasting torque decreases gradually in the coasting torque convergence range.

In accordance with the first setting data, in a low-speed range lower than the stop control entrance speed (for example, 3 km/h), coasting torques under the same vehicle speed condition may be set to have the same negative (−) value at all regenerative braking levels D0-D3, irrespective of regenerative braking levels. In addition, an absolute value of coasting torque may be set to have a value linearly reduced as the vehicle speed is reduced from the stop control entrance speed to 0 km/h. According to embodiments of the present disclosure, the low-speed range lower than the stop control entrance speed is a range in which stop control is performed in the one-pedal mode on and activation states.

In addition, in accordance with the first setting data, a creep torque according to vehicle speed is not set. Accordingly, the vehicle is stopped only by a coasting torque without generation of a creep torque, in the one-pedal (i-pedal) on and activation states.

On the other hand, in accordance with the second setting data, a coasting torque and a creep torque with respect to a vehicle speed may be set in a manner identical or similar to those of D1-D3 in FIG. 5. In addition, in accordance with the second setting data, absolute values of coasting torques and variation gradients of coasting torques at different regenerative braking levels D0-D3 are set to have different values, respectively, in order to distinguish regenerative strengths from one another stepwise.

In addition, in accordance with the second setting data, no coasting torque is applied at the level D0, and an absolute value of coasting torque at each of the regenerative braking levels D1-D3 may be set to have a value gradually reduced as the vehicle speed is reduced from the coasting-variable reference speed (for example, 25 km/h) to a reference speed for creep initiation (for example, 9 km/h). In this case, the coasting torque at the reference speed for creep initiation may be set to have a value gradually reduced until the coasting torque reaches zero torque (0 Nm).

In addition, in accordance with the second setting data, a torque in a positive (+) direction, i.e., a torque having a positive (+) value, varying in accordance with a vehicle speed under the condition that the vehicle speed is lower than the reference speed for creep initiation is set as a creep torque. In this case, under the same vehicle speed condition, creep torques may be set to have the same value at all regenerative braking levels, irrespective of regenerative braking levels. Each creep torque may be set to have a value gradually increased in accordance with a reduction in vehicle speed.

As can be seen from FIG. 5, in conventional electric vehicles, a one-pedal (“i-pedal”) level is provided as a regenerative braking level stronger than the regenerative braking level D3, and stop control is impossible at the regenerative braking levels D0-D3 other than the one-pedal level set as a maximum regenerative strength.

On the other hand, according to embodiments of the present disclosure, stop control may be performed at all of a plurality of regenerative braking levels having different regenerative strengths in on and activation states of the one-pedal mode, and a coasting torque according to a vehicle speed is not separately set and provided only for the one-pedal mode, as can be seen from FIG. 6.

As should be apparent from the above description, according to embodiments of the present disclosure, the one-pedal mode may be switched on/off irrespective of a regenerative braking level, and coasting torque setting data only for the one-pedal mode is not separately provided. Only first setting data with a coasting torque with respect to a vehicle speed set therein in order to be used in one-pedal mode on and activation states, and second setting data with a coasting torque with respect to a vehicle speed set therein in order to be used in a one-pedal mode off or deactivation state are provided.

Referring to FIG. 6, a coasting torque is gradually linearly reduced in a low-speed range in which the vehicle speed is not higher than the coasting-variable reference speed in on and activation states of the one-pedal mode. In on and activation states of the one-pedal mode, accordingly, linear deceleration is possible even during coasting. In addition, a coasting torque with respect to a vehicle speed may be set to reduce motion sickness occurring in tip-out.

Referring to FIG. 7, a coasting torque and a creep torque according to a vehicle speed when the one-pedal mode is in an off state, according to an embodiment, are illustrated. When the driver selects “creep allowance in parking” through the input device 12, the controller 20 compares the vehicle speed with a critical speed for acceleration determination (for example, 20 km/h) when the gear stage is returned to the D-stage after entering the R-stage.

In this case, the controller 20 may determine that there is an acceleration intention of the driver when the vehicle speed is increased over a critical speed for acceleration determination after reaching the critical speed for acceleration determination. The controller 20 may then set a coasting torque corresponding to the current regenerative braking level previously selected by the driver to be used.

In addition, in an off or deactivation state of the one-pedal mode, the controller 20 generates a creep torque corresponding to the current vehicle speed through motor control under an accelerator pedal off condition when the vehicle speed does not reach the critical speed for acceleration determination (for example, 20 km/h) even after the gear stage is shifted to the R-stage or is returned from the R-stage to the D-stage.

In addition, when the vehicle is accelerated to the critical speed for acceleration determination (for example, 20 km/h) or more after the gear stage is returned to the D-stage, the controller 20 may perform stop control after again transitioning to a coasting torque using state. In this case, setting data of FIG. 7 may be used in an off state of the one-pedal mode. However, when deactivation of the one-pedal mode is released in an on state of the one-pedal mode and, accordingly, the one-pedal mode is activated, setting data of FIG. 6 may be used after the vehicle speed is subsequently increased to the coasting-variable reference speed (25 km/h) or more.

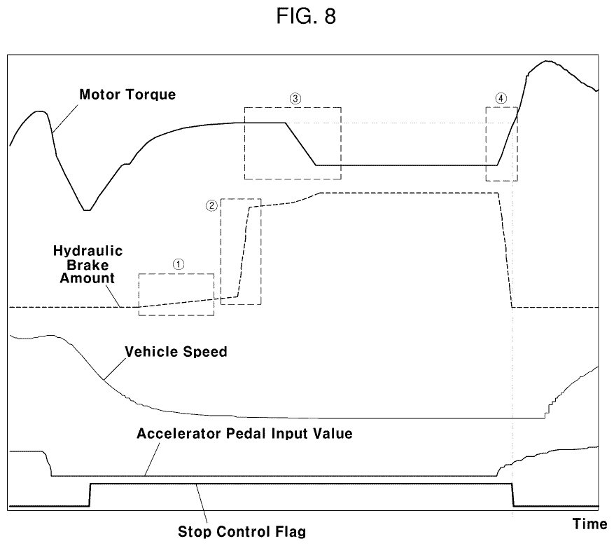

FIG. 8 is a view illustrating a state in which stop control according to embodiments of the present disclosure is performed. FIG. 8 illustrates a motor and friction braking cooperation control torque profile in a slope driving situation. In FIG. 8, a motor torque generated during deceleration is a coasting torque which is a negative (−) torque.

The controller 20 enters stop control when the vehicle speed becomes lower than a stop control entrance speed (for example, 3 km/h) (generation of a stop control flag). As illustrated in region \textcircled{1} in FIG. 8, the controller 20 then gradually increases a hydraulic brake amount when the vehicle speed becomes lower than a reference speed for braking application (for example, 1 km/h) in accordance with deceleration after stop control entrance, thereby generating braking force.

Subsequently, as illustrated in region \textcircled{2} in FIG. 8, the controller 20 abruptly increases a hydraulic brake amount after completion of vehicle stop. Further, as illustrated in region \textcircled{3} in FIG. 8, the controller 20 then removes a motor torque. Here, motor torque removal means that the motor torque is controlled to be 0. In addition, hydraulic brake amount increase means that a hydraulic brake pressure is applied to the brake device 33, which is a hydraulic braking device, to increase a frictional braking torque and a frictional braking force for a vehicle wheel.

It may be possible to suppress a vehicle pitching motion generated when a motor torque is removed and to minimize groan noise by abruptly increasing the hydraulic brake amount after completion of vehicle stop. In addition, an enhancement in real-road fuel economy may be achieved by preventing use of unnecessary energy during vehicle stop through motor torque removal.

In addition, the controller 20 stores a motor torque value before removal thereof in as illustrated in region \textcircled{3} in FIG. 8, and uses the stored motor torque value when stop control is subsequently removed. When accelerator pedal input and manipulation by the driver are detected, the controller 20 determines that there is a stop control release request. The controller 20 thus releases a frictional braking state by the brake device 33 (release of hydraulic brake pressure) and simultaneously returns the motor torque to a stored value as illustrated in region \textcircled{4} in FIG. 8. Through control of starting of the vehicle in this state, it may be possible to prevent the vehicle from slipping when the vehicle starts on an uphill road.

Hereinafter, control procedures according to embodiments of the present disclosure and the related art are described through comparison thereof with reference to the following flowcharts.

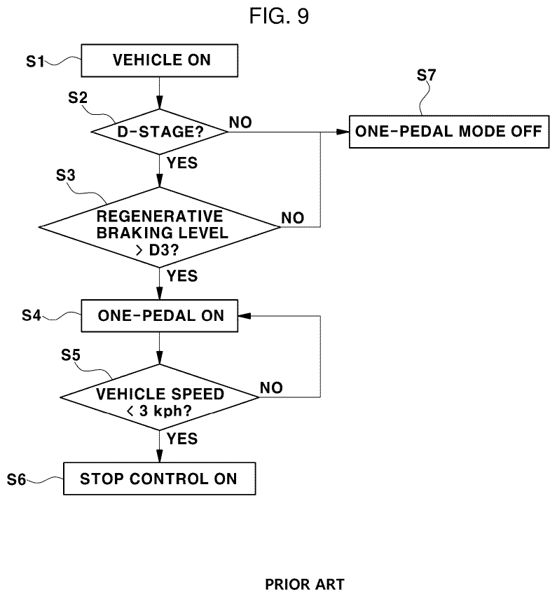

FIG. 9 is a flowchart illustrating procedures for one-pedal mode on/off determination and stop control entrance determination according to the related art. As illustrated in FIG. 9, a vehicle on state may be activated in an operation S1, In an operation S2, a controller determines whether the gear stage is a driving stage, i.e., the D-stage. In an operation S3, the controller determines whether a level higher than the level D3 (the level “i-Pedal” in FIG. 5) is selected as a regenerative braking level.

When the D-stage is selected (Yes in the operation S3), and a level higher than the level D3 (“i-Pedal”) is then selected, the one-pedal mode is switched on in an operation S4. Here, the one-pedal mode (for example, the i-pedal mode) is a mode in which a coasting torque having a maximum regenerative strength is set (e.g., “i-Pedal” illustrated in FIG. 5).

In an operation S5, the controller compares a vehicle speed with a stop control entrance speed (for example, 3 km/h). When the vehicle speed becomes lower than the stop control entrance speed, stop control is switched on in an operation S6. Accordingly, stop control is performed by the controller. On the other hand, when the gear stage is not the D-stage (No in the operation S2) or a level not higher than the level D3 is selected as the regenerative braking level (No in the operation S3), the controller maintains an off state of the one-pedal mode in an operation S7.

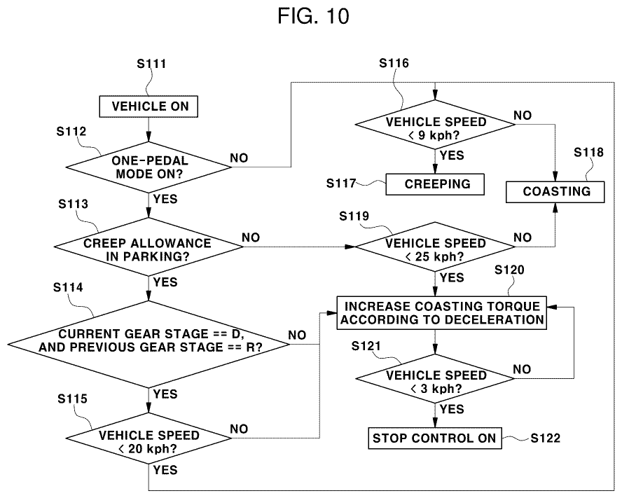

FIG. 10 is a flowchart illustrating procedures for determining stop control, creeping, and coasting in accordance with an embodiment of the present disclosure. In an operation S111, a vehicle on state may be activated. In an operation S112, the controller 20 determines whether the one-pedal mode is switched to an on state is determined. When the driver switches on the one-pedal mode using a paddle which is the manipulation device 11, the controller 20 checks whether a current state is a state in which “creep allowance in parking” (e.g., “creep allowance in parking” illustrated in FIG. 2) has been selected in an operation S113.

When the current state is a state in which the driver has selected “creep allowance in parking” using the input device 12, the controller 20 determines whether a previous gear stage is a reverse driving stage (e.g., the R-stage) and whether the current gear stage is a forward driving state, (e.g., the D-stage) in an operation S114.

When the previous gear stage is the reverse driving stage, i.e., the R-stage, and the current gear stage is the forward driving state, i.e., the D-stage, the controller 20 compares the vehicle speed with a critical speed for acceleration determination (for example, 20 km/h) in an operation S115. When the vehicle speed is lower than the critical speed for acceleration determination (Yes in the operation S115), the controller 20 compares the vehicle speed with a reference speed for creeping initiation (for example, 9 km/h) in an operation S116. When the vehicle speed is lower than the reference speed (Yes in the operation S116), the controller 20 determines that a current mode is still in a parking mode, and performs control for creeping in an operation S117.

For control for creeping, the controller 20 may control a motor torque in order to generate a creep torque corresponding to the regenerative braking level selected by the driver and a real-time vehicle speed. In accordance with this control, creeping of the vehicle is carried out. Here, the creep torque is determined by a value corresponding to the real-time vehicle speed, e.g., from the second setting data of FIG. 7.

On the other hand, when the vehicle speed is not lower than the reference speed for creeping initiation even though the current mode is the parking mode in which the vehicle speed is lower than the critical speed for acceleration determination, the controller 20 controls the motor torque using a coasting torque corresponding to the regenerative braking level selected by the driver. Accordingly, coasting is carried out in an operation S118 (coasting torque being variable).

In addition, when the one-pedal mode is in an OFF state in the operation S112, the controller 20 does not perform stop control, and then performs control such that creeping of the vehicle in the operation S117 is carried out when the vehicle speed becomes lower than the reference speed for creeping initiation (for example, 9 km/h) in the operation S116.

In addition, when the vehicle speed is not lower than the reference speed for creeping initiation in step S116 in the off state of the one-pedal mode, the controller 20 controls the motor torque using the coasting torque corresponding to the regenerative braking level selected by the driver. Accordingly, coasting is carried out in an operation S118 (coasting torque being variable).

In addition, when “creeping prohibition in parking” has previously been selected by the driver (No in the operation S113) in the on state of the one-pedal mode (an activation state of the one-pedal mode), the current vehicle speed is compared with a coasting-variable reference speed (25 km/h) in an operation S119. In this case, when the current vehicle speed is not lower than the coasting-variable reference speed (No in the operation S119), the controller 20 controls the motor torque using a constant coasting torque corresponding to the regenerative braking level selected by the driver, using the first setting data of FIG. 6. Accordingly, coasting is carried out in the operation S118 (coasting torque being constant).

On the other hand, when the current vehicle speed is in a low speed range in which the current vehicle speed is lower than the coasting-variable reference speed (Yes in the operation S119), the controller 20 controls the motor torque using a coasting torque (“coasting torque convergence range”) determined by a value corresponding the regenerative braking level currently selected by the driver and the real-time vehicle speed, e.g., from the first setting data of FIG. 6, and increases the coasting torque in accordance with a reduction in vehicle speed in an operation S120.

Subsequently, the controller 20 performs control to increase the coasting torque until the vehicle speed reaches the stop control entrance speed (for example, 3 km/h). When the vehicle speed becomes lower than the stop control entrance, as determined in an operation S121, stop control is switched on, and is then performed by the controller 20 in an operation S122 (e.g., using the first setting data of FIG. 6).

In addition, when conditions that the previous gear stage is the R-stage, and the current gear stage is the D-stage are not satisfied or when the current vehicle speed is not lower than the critical speed for acceleration determination (for example, 20 km/h) (No in the operation S115), the controller 20 proceeds to the operation S120. Accordingly, the controller 20 performs control to increase the coasting torque in accordance with a reduction in vehicle speed (e.g., using the second setting data of FIG. 7), and performs stop control when the vehicle speed becomes lower than the stop control entrance speed (for example, 3 km/h) in the operation S122.

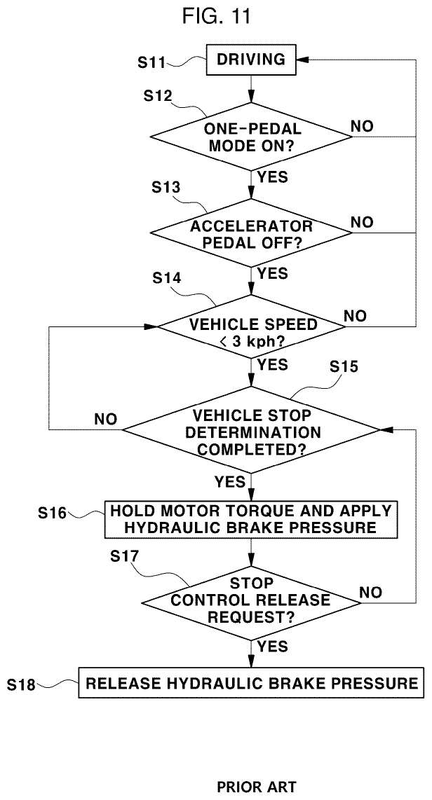

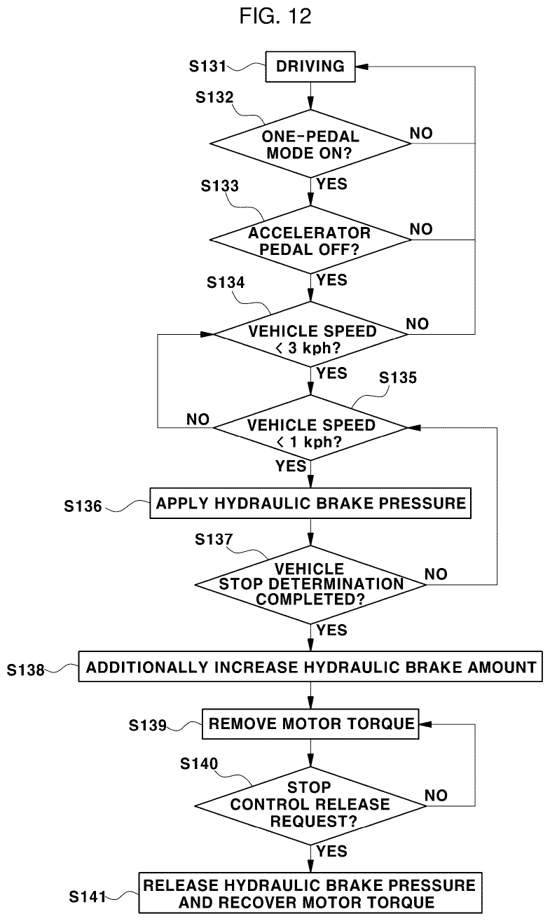

FIG. 11 is a flowchart illustrating a stop control procedure according to the related art. FIG. 12 is a flowchart illustrating a stop control procedure according to an embodiment of the present disclosure.

In the related art, as illustrated in FIG. 11, during vehicle driving in an operation S11, a controller checks whether a current state is a one-pedal mode on state and an accelerator pedal off state in operations S12 and S13, respectively. When the current state is the one-pedal mode on state and the accelerator pedal off state, the controller determines whether a vehicle speed becomes lower than a stop control entrance speed (for example, 3 km/h) in an operation S14.

When the vehicle speed becomes lower than the stop control entrance speed, the controller determines whether stop of the vehicle has been completed in an operation S15. After completion of stop of the vehicle, the controller holds a motor torque, and then applies a hydraulic brake pressure, thereby operating the brake device 33 in an operation S16. Thereafter, the controller releases the hydraulic brake pressure in an operation S18 in accordance with a stop control release request determined in an operation S17.

According to an embodiment of the present disclosure, as illustrated in FIG. 12, during vehicle driving in an operation S131, the controller 20 checks whether a current state is a one-pedal mode on state and an accelerator pedal off state in operation S132 and S133, respectively. When the current state is the one-pedal mode on state and the accelerator pedal off state, the controller 20 determines whether a vehicle speed becomes lower than a stop control entrance speed (for example, 3 km/h) in an operation S134. When the vehicle speed subsequently becomes lower than a reference speed for braking application (for example, 1 km) after being lower than the stop control entrance speed, as determined in an operation S135, the controller 20 applies frictional braking force to a vehicle wheel through application of a hydraulic brake pressure in an operation S136.

Subsequently, the controller 20 additionally increases the hydraulic brake pressure in an operation S138 in a state in which stop of the vehicle has been completed as determined in an operation S137. In an operation S139, the controller 20 removes a motor torque. In this case, the controller 20 stores a motor torque maintained just before motor torque removal.

In an operation S140, the controller 20 determines, from an accelerator pedal input of the driver (accelerator pedal on), whether there is a stop control release request. When the controller 20 determines that there is a stop control release request, the controller 20 releases the hydraulic brake pressure, and simultaneously recovers the motor torque to the value stored just before the motor torque removal in an operation S141. Accordingly, operation of the brake device 33 is released, and operation of the motor 32 is controlled to generate the motor torque stored just before the motor torque removal.

Heretofore, a driving control apparatus and method, according to the embodiments of the present disclosure, have been described in detail. The driving apparatus and method, according to embodiments of the present disclosure, provide stop control at all regenerative braking levels. Accordingly, stop control may be performed even at a low regenerative braking level.

In addition, according to embodiments of the present disclosure, in accordance with setting data obtained through mapping of torque according to vehicle speed, predetermined coasting torques are set for different regenerative braking levels, respectively, in a range not lower than a coasting-variable reference speed (for example, 25 km/h), identically to the case in which a one-pedal mode is switched off. However, in a range lower than the coasting-variable reference speed, a linearly-varying coasting torque is set in order to enable the vehicle to be completely stopped after being gradually decelerated.

Since a linear coasting torque is set to enable the vehicle to be completely stopped after being gradually decelerated in a range lower than the coasting-variable reference speed, it is unnecessary for the driver to repeatedly manipulate the accelerator pedal due to excessive deceleration. A deceleration variation upon tip-out for coasting in the one-pedal mode is also not excessive. Accordingly, motion sickness of a passenger may not occur.

In addition, according to embodiments of the present disclosure, the driver may select creep allowance or creep prohibition through a user setting menu. For example, as described with reference to FIG. 2, the driver may select “creep allowance in parking” or “creep prohibition in parking” through the user setting menu.

When the driver selects “creep allowance in parking”, the one-pedal mode is temporarily deactivated under the condition that the gear stage is shifted to the R-stage during parking. Accordingly, creeping may be performed. In addition, when an acceleration intention of the driver is identified under the condition that the gear stage is subsequently returned to the D-stage, the one-pedal mode is automatically activated. Accordingly, an effort of the driver to again switch on the one-pedal mode through manual manipulation, as in conventional cases, may be unnecessary.

On the other hand, when the driver wants stop control even in the R-stage, the driver is allowed to select “creep prohibition in parking”. In this case, it may be possible for the driver to experience consistent stop control in both the D-stage and the R-stage.

In addition, according to embodiments of the present disclosure, unnecessary motor torque after completion of vehicle stop determination may be removed. Accordingly, fuel economy in the one-pedal mode may be enhanced, and over-heating of a power electric (PE) system including a motor may be prevented.

Furthermore, according to embodiments of the present disclosure, when stop control is released, a motor torque is rapidly applied in order to prevent occurrence of a vehicle slipping phenomenon. Accordingly, an enhancement in drivability may also be achieved.

The present disclosure has been described in detail with reference to embodiments thereof. However, it should be appreciated by those having ordinary skill in the art that changes may be made in these embodiments without departing from the principles and spirit of the present disclosure, the scope of which is defined in the appended claims and their equivalents.

What is claimed is:

1. A driving control apparatus of a vehicle, the driving control apparatus comprising:
a manipulation device configured to allow selection on/off states of a one-pedal mode;
an input device configured to allow setting of creep allowance in parking or creep prohibition in parking;
a vehicle speed detector configured to detect a vehicle speed; and
a controller connected to the manipulation device, the input device, and a driving information detector, wherein the controller is configured to
determine whether the vehicle speed detected by the vehicle speed detector is not higher than a predetermined reference speed for creep initiation, when i) the on state of the one-pedal mode is selected through the manipulation device and ii) creep allowance in parking is set through the input device, and
control a motor configured to drive the vehicle such that the motor generates a creep torque in the on state of the one-pedal mode, in response to determining that the vehicle speed is not higher than the predetermined reference speed for creep initiation.

2. The driving control apparatus according to claim 1, wherein the controller is further configured to:
control operation of a display device to display a user setting menu for enabling a driver to select one of creep allowance in parking or creep prohibition in parking; and
receive setting information as to creep allowance in parking or creep prohibition in parking selected by the driver through the input device.

3. The driving control apparatus according to claim 1, wherein the controller is further configured to:
determine whether a previous gear stage is an R-stage and whether a current stage is a D stage, when i) the on state of the one-pedal mode is selected and ii) creep allowance in parking is set; and
determine whether the vehicle speed is not higher than the predetermined reference speed for creep initiation in response to determining that i) the previous gear stage is the R-stage and ii) the current stage is the D stage.

4. The driving control apparatus according to claim 1, wherein the controller is further configured to perform a control operation for the one-pedal mode when the vehicle is accelerated in the on state of the one-pedal mode such that the vehicle speed is not lower than a predetermined critical speed for acceleration determination, after controlling the motor to generate the creep torque.

5. The driving control apparatus according to claim 1, wherein:
a plurality of regenerative braking levels is set in the controller; and
the controller is configured to
control the motor by a coasting torque corresponding to a regenerative braking level currently selected from among the plurality of regenerative braking levels during execution of a control operation for the one-pedal mode, and
linearly vary a costing torque according to each of the regenerative braking levels from a predetermined coasting-variable reference speed to a predetermined stop control entrance speed in a coasting torque convergence range as a vehicle speed range i) not higher than the predetermined coasting-variable reference speed and ii) not lower than the predetermined stop control entrance speed.

6. The driving control apparatus according to claim 5, wherein:
coasting torques of the plurality of regenerative braking levels are set, in the controller, to be converged to a same torque value at the predetermined stop control entrance speed;
the coasting torques of the plurality of regenerative braking levels are set, in the controller, to have a same value in a stop control range from the predetermined stop control entrance speed to 0 km/h; and
the costing torques set to have the same value in the stop control range are linearly reduced in accordance with a reduction in vehicle speed.

7. The driving control apparatus according to claim 1, wherein:
a plurality of regenerative braking levels is set in the controller; and
the controller is configured to control the motor by a coasting torque corresponding to a regenerative braking level currently selected from among the plurality of regenerative braking levels, in response to determining that i) the one-pedal mode is in the on state and ii) creep prohibition in parking is set.

8. The driving control apparatus according to claim 7, wherein the controller is further configured to, in response to determining that the vehicle speed becomes lower than a predetermined stop control entrance speed in an accelerator pedal off state during control of the motor by the coasting torque, control operation of a brake device to apply a braking force until the vehicle stops.

9. The driving control apparatus according to claim 8, wherein the controller is further configured to, in response to determining that the vehicle speed becomes lower than the predetermined stop control entrance speed, control operation of the brake device to apply braking force when the vehicle speed becomes lower than a predetermined reference speed for braking application.

10. The driving control apparatus according to claim 8, wherein the controller is further configured to:
control operation of the brake device to increase the braking force in response to determining that stop of the vehicle has been completed by the braking force of the brake device; and
perform motor torque removal to control the motor such that a motor torque of the motor becomes zero, after the braking force increases.

11. The driving control apparatus according to claim 10, wherein the controller is further configured to:
store a motor torque maintained before execution of the motor torque removal; and
release operation of the brake device when an accelerator pedal input by a driver is subsequently generated, and concurrently control operation of the motor to generate the stored motor torque.

12. A driving control method of a vehicle, the driving control method comprising:
determining, by a controller, on/off states of a one-pedal mode and information as to setting of creep allowance in parking/creep prohibition in parking;
determining, by the controller, whether or not a vehicle speed is not higher than a predetermined reference speed for creep initiation, in response to determining that i) the one-pedal mode is in the on state and ii) creep allowance in parking is set; and
controlling, by the controller, a motor configured to drive the vehicle such that the motor generates a creep torque in the on state of the one-pedal mode, when the vehicle speed is not higher than the predetermined reference speed for creep initiation.

13. The driving control method according to claim 12, further comprising:
determining, by the controller, whether a previous gear stage is an R-stage and whether a current stage is a D stage, in response to determining that i) the one-pedal mode is in the on state and ii) creep allowance in parking is set, before determining whether or not the vehicle speed is not higher than the predetermined reference speed for creep initiation,
wherein determining whether or not the vehicle speed is not higher than the predetermined reference speed for creep initiation is performed in response to determining that i) the previous gear stage is the R-stage and ii) the current stage is the D stage.

14. The driving control method according to claim 12, further comprising performing, by the controller, a control operation for the one-pedal mode when the vehicle is accelerated in the on state of the one-pedal mode such that the vehicle speed is not lower than a predetermined critical speed for acceleration determination, after controlling the motor to generate the creep torque.

15. The driving control method according to claim 14, further comprising controlling, by the controller, the motor by a coasting torque corresponding to a regenerative braking level currently selected from among a plurality of regenerative braking levels during execution of the control operation for the one-pedal mode, thereby decelerating the vehicle.

16. The driving control method according to claim 12, wherein:
a plurality of regenerative braking levels is set in the controller; and
the method further comprises
controlling, by the controller, the motor by a coasting torque corresponding to a regenerative braking level currently selected from among the plurality of regenerative braking levels during execution of control operation for the one-pedal mode, and
linearly varying, by the controller, a costing torque according to each of the regenerative braking levels from a predetermined coasting-variable reference speed to a predetermined stop control entrance speed in a coasting torque convergence range as a vehicle speed range i) not higher than the predetermined coasting-variable reference speed and ii) not lower than the predetermined stop control entrance speed.

17. The driving control method according to claim 12, further comprising:
controlling, by the controller, the motor using a coasting torque corresponding to a regenerative braking level currently selected from among a plurality of regenerative braking levels, under a condition that the plurality of regenerative braking levels is set in the controller, in response to determining that i) the one-pedal mode is in the on state and ii) creep prohibition in parking is set.

18. The driving control method according to claim 17, further comprising:
determining, by the controller, whether the vehicle speed becomes lower than a predetermined stop control entrance speed in an accelerator pedal off state during control of the motor by the coasting torque; and
controlling, by the controller, operation of a brake device to apply a braking force until the vehicle stops, upon determining that the vehicle speed becomes lower than the predetermined stop control entrance speed.

19. The driving control method according to claim 18, further comprising:
controlling, by the controller, operation of the brake device to increase the braking force, upon determining that stop of the vehicle has been completed by the braking force of the brake device; and
performing, by the controller, motor torque removal to control the motor such that a motor torque of the motor becomes zero, after the braking force increases.

20. The driving control method according to claim 19, further comprising:
storing, by the controller, a motor torque maintained just before execution of the motor torque removal; and
releasing, by the controller, operation of the brake device when an accelerator pedal input by a driver is subsequently generated, and simultaneously controls operation of the motor to generate the stored motor torque.
